(19) United States
(12) Patent Application Publication
(10) Pub. No.: US 2024/0279084 A1
(43) Pub. Date: Aug. 22, 2024

(54) Method and Apparatus for the Generation of Colloidal Gas Aphrons (CGA) for the Removal and Concentration of Per- and Polyfluoroalkyl Substances (PFAS)

(71) Applicant: Ovivo Inc., Montreal (CA)

(72) Inventors: Anthony Guadalupe Galvan, Monument, CO (US); Katie Lynn Henderson, Salt Lake City, UT (US); Mark Thomas Machacek, Saint Paul, MN (US)

(21) Appl. No.: 18/584,863

(22) Filed: Feb. 22, 2024

Related U.S. Application Data
(60) Provisional application No. 63/447,574, filed on Feb. 22, 2023.

(51) Int. Cl. C02F 1/52; C02F 1/44; C02F 101/36

(52) U.S. Cl. CPC C02F 1/52; C02F 1/44; C02F 2101/36; C02F 2305/04

(57) ABSTRACT

PFAS (Per- and polyfluoroalkyl substances) contained in water are remediated by a process in which colloidal as aphrons (CGAs) are generated under shear and with surfactants, either added to the liquid or inherent in the PFAS. Preferably a pump is used to generate the CGAs, to move CGAs and liquid through the system, and to induce gas or air into the pump. The resulting foam that rises to the surface is comprised of various small bubbles, producing a very large surface area effective in attracting PFAS by surface adsorption, and when the foam is removed a small volume of liquid highly concentrated in PFAS can be efficiently destroyed by various known destruction techniques. The method is effective to remove PFOS.

### BACKGROUND OF THE INVENTION

This application claims benefit of provisional application Ser. No. 63/447,574, filed Feb. 22, 2023.

This invention concerns removal and concentration of deleterious substances from a liquid, and is concerned with remediation of per-and-polyfluoroalkyl (PFAS) in drinking water, wastewater, leachates, and other solids and liquid applications.

PFAS are a family of synthetic organic compounds that have been introduced to the environment through production and use in industrial and consumer products since the 1940s. This class of chemicals is characterized by a series of strong carbon-fluorine bonds and are thermally and chemically stable and resistant to breaking down in the environment, earning them the nickname, “the forever chemicals.” These chemicals are persistent, mobile, and can bioaccumulate, as such they have been found in the blood of an estimated 97% of Americans. Further, scientists have found links between a number of these chemicals and many negative health effects including kidney and testicular cancer, thyroid issues, and other developmental effects.

PFAS contamination is widespread and global resulting in populations being directly exposed to these persistent chemicals through their drinking water source which have been found to escape some common treatment methods.

The family of PFAS chemicals has caught attention of the public and scientific community in recent years, in large part due to recent advancement in analytical methods that allow for detection of low levels of PFAS in the environment down to the parts per trillion concentrations. Regulators and public health officials are becoming increasingly concerned that the current data links even low levels of exposure of certain PFAS to negative human health and environmental effects.

Based off toxicity and epidemiological study findings in 2023, EPA announced the proposed National Primary Drinking Water Regulation (NPDWR) for six PFAS including perfluorooctanoic acid (PFOA), perfluorooctane sulfonic acid (PFOS), perfluorononanoic acid (PFNA), hexafluoropropylene oxide dimer acid (HFPO-DA, commonly known as GenX Chemicals), perfluorohexane sulfonic acid (PFHxS), and perfluorobutane sulfonic acid (PFBS). In addition, to the proposed regulation in drinking waters in 2022 EPA proposed the designation of PFOA and PFOS, including their salts and structural isomers as hazardous substances under the Comprehensive Environmental Response, Compensation, and Liability Act (CERCLA). In February of 2024 the EPA proposed adding seven more specific PFAS to their list of hazardous constituents. If these regulations are finalized it would require nationwide treatment if PFAS in drinking water and cleanup of designated hazardous substances through CERCLA corrective action in all types of water.

These PFAS chemicals have been detected at environmentally significant levels in nearly all regions of the world. The adverse effects of PFAS not only affect humans, but also wildlife and plants, increasing the importance of society to address this widespread contamination. With the current PFAS treatment and remediation strategies and technologies applied to drinking water and industrial wastewater, harm to humans may be alleviated by removing PFAS, but the residual PFAS wastes generated from current treatment technologies are mainly allowed to persist.

The most widely used treatment solution for the removal of PFAS is by adsorption onto a single use media that when spent is either sent to a landfill or incinerated. If sent to a landfill the PFAS will eventually transfer to the leachate and potentially back into the environment if not treated for PFAS before discharge. The effectiveness of incineration to destroy PFAS and the tendency for formation of fluorinated or mixed halogenated organic byproducts is not well understood. To eliminate the transferring of the PFAS to the environment, a treatment solution is needed that can remove PFAS and reduce the waste volume into a highly concentrated liquid stream, allowing for economic destruction of PFAS.

Another treatment solution to remove PFAS is Reverse Osmosis (RO) which is known to be effective for the removal of most PFAS; however, the liquid waste stream generated is still 10% to 20% of the initial volume. That volume of waste generated can be cost prohibitive to treat with PFAS destruction methods. A method to reduce the PFAS contaminated liquid volume required for treatment to below 10% of the initial volume will increase the viability and energy efficiency for destruction of PFAS, reducing or eliminating the potential for transferring PFAS back into the environment.

The use of surfactants in the mining industry has been around for some time dating back to 1906. In fact, the froth flotation process was patented by E. L. Sulman, H. F. K. Pickard, and John Ballot in 1906. Froth flotation was used to selectively separate hydrophobic minerals from hydrophilic waste. Froth flotation for mineral capture employed the use of surfactants that aided in generating bubbles that insoluble mineral particles would attach to and then rise to the surface to be collected and recovered. Using a surfactant allowed the bubble to be tailored to the mineral particle size distribution. For bubble-particle attachment to occur, surface condition of the mineral or other substance is controlled by its hydrophobicity. Kinetic factors intervene in the flotation separation process; they include:
bubble-particle collision
rupture of the liquid film
type of surface-active agent(s) and charge
thinning of the liquid film between bubble and particle rapid expansion of the air meniscus over the particle so that a stable attachment has been achieved.

Once the mineral is recovered, it can undergo additional upgrading (enrichment). Mineral upgrading is done by additional cleaning through subsequent flotation stage(s). Depending on the upgrading target/kinetics, the number of additional flotation stages can be determined.

Over the years, froth flotation has been adapted for use in various capacities such as dissolved air flotation, induced air flotation, conventional flotation, and column flotation that generated bubbles in combination with surfactants, gas, and a liquid stream.

Froth flotation used in mineral beneficiation uses surface-active agents, surfactants, that aid in generating bubbles. Just like mineral flotation systems, a surfactant can be used to generate a tailored bubble size and type that can function to remove or recover a material. In the use of foam flotation with CGA bubbles, the bubbles function as a medium where the PFAS can be separated based on its hydrophobicity and electrostatic attraction. PFAS themselves are surfactants; the longer the alkyl tails of the specific compound, the more hydrophobic these substances are. To further remove and concentrate the PFAS, an additional flotation step of a cleaning (concentrating) and/or scavenger (polishing) stage may be employed. During the subsequent cleaning stage(s), the drivers are either additional concentrating of the PFAS and liquid reduction (concentrator) or further polishing the retentate (scavenger).

Diffused gas bubbles produce a less stable and thinner film layer than CGA bubbles. Due to the thinner film layer of diffused gas bubbles, coalescence occurs resulting in expanded bubble size and less water content, producing a dryer foam. One advantage of diffused gas bubbles is they can produce less-volume due to dryer foam. The disadvantage of diffused gas bubbles is due to the increased coalescing of the bubbles that affect the treatment efficiency due to the increased sizes and decreased surface area of the bubbles. The type of bubbles during each foam flotation stage(s) can utilize CGA bubbles and/or diffused gas bubbles depending on the treatment goals.

FIG. 1 is an illustration of a simplified process flow diagram for the use of foam flotation in the mining industry for mineral removal/recovery and is generally the same process flow diagram used with CGA and/or diffused gas bubbles to remove and concentrate PFAS which can be run in a batch or continuous flow operation. The illustrated rougher stage represents the beginning of the flotation circuit that, for purposes of the current invention, concentrates PFAS (foamate). In the rougher, the bulk of treated liquid (retentate) volume is removed and the PFAS will be concentrated in the foam layer and removed as foamate. Retentate, which has a reduced PFAS concentration, can be treated similarly again in the scavenger stage using CGAs or diffused air to further remove any remaining PFAS. The foamate collected from both the rougher and scavenger treatment stage can be further concentrated through a cleaner stage using similar treatment again with CGA and/or diffused gas bubbles.

FIGS. 2 and 3 illustrate the CGA and diffused or induced gas bubbles, respectively. Diffused or induced gas (bubbles and surfactants if required are added to liquid) forms a larger, drier, more geometric mono-film bubble layer shell versus CGA bubbles, generated with this invention, that have multi-layer gas/liquid shells as described by Dr. Sebba. The CGA bubbles shown in FIG. 2 were generated with the current invention. FIG. 4 is an illustration of CGA (multi-layer shells), according to Dr. Sebba.

Others have reported generating a type of CGA bubble using charged surfactants referencing Dr. Sebba's work. Of known technology is Heron Innovators who market their product as Suspended Air Flotation (SAF®) using charged surfactants. They specifically target insoluble material (suspended solids) for wastewater treatment. FIG. 4A illustrates the CGA bubble generator using a spinning disc illustrated in Dr. Sebba's book entitled “Foams and Bi-liquid Foams-Aphrons,” 1987. Companies such as OPEC, ect2, Altra, Evocra and others use the term foam fractionation/floatation and do not call out CGA for their bubble type to remove PFAS.

GSI Environmental Inc. (GSI), has also generated a type of CGA bubble utilizing a high shear spinning disc similar to Sebba's CGA generation system for mixing gas, liquid, and surfactants. GSI's CGA bubbles are introduced into a separate separation vessel for removal of PFAS with CGA-containing foam. The initial work of GSI was only on removal of dyes as surrogates of PFAS, but additional sets of experiments were conducted with synthetic water containing PFAS compounds. Varying PFAS removal efficiencies were documented in the synthetic water experiments showing good removal of short chain chemicals PFBS and PFBA, with notably no removal of PFOS, a long chain compound. The importance of removing PFOS is due to the EPA's proposed enforceable limit of 4 ppt under National Pollution Discharge Waste Requirements (NPDWR) and designation as a hazardous substance under RCRA. Reference: GSI Patent No. 11,679,999.

### SUMMARY OF THE INVENTION

With the current invention, a treatment process and apparatus has been developed in which PFAS can be removed and concentrated by means of foam fractionation utilizing surfactants, including PFAS surfactants themselves, to generate Colloidal Gas Aphron (CGA) that PFAS adsorb onto and are separated and removed. The surfactants can be charged or non-charged, and included PFAS surfactants themselves. The CGA bubbles remove, concentrate, and reduce the volume of concentrated liquid waste containing PFAS. By concentrating the PFAS and reducing the volumetrically concentrated liquid, a downstream destruction technology can be smaller, more efficient, and more economically feasible or the disposal volumes of PFAS waste streams and costs are significantly reduced.

Pursuant to the invention, a type of CGA bubbles are generated in a liquid using existing or additional charged and noncharged surfactants (i.e., cationic, anionic, non-ionic) and a gas in relatively low shear (mixing) environment produced by a commercially available pump (preferably <5,000 RPM) and/or nozzle. The generated CGAs, as pictured in FIG. 3, by this method and apparatus in this invention exhibited the same multilayer shell gas-liquid bubble produced by the high shear spinning disc developed by Dr Sebba.

The generation of the CGA bubble matrix allows the PFAS to orientate into their polar and non-polar position, thus adsorbing to and concentrating PFAS and reducing the liquid volume. Surfactant ions are thermodynamically more stable when they are adsorbed at an interface than when in the bulk of an aqueous solution according to Sebba. CGA bubbles are generated by introducing a gas (i.e., ozone, air, etc.) and varying surfactant dosages and surfactant charge (i.e., cationic, anionic, non-ionic) into a liquid with shear in a CGA bubble reactor where gas and surfactant(s) are commingled and then separated either in the same reactor or in a separation vessel.

Foam flotation with the use of CGA allows for PFAS to be more selectively removed and concentrated in a small volume of liquid where it can be more economically disposed of or destroyed with energy intensive technologies. The CGA bubble structure is fundamentally different from diffused gas bubbles as they are smaller and more stable, reducing bubble coalescence, resulting in more bubble surface area for treatment and improving PFAS removal and concentration factors. This type of CGA bubble generator used in the foam flotation process with the rougher, concentrator, and or scavenger treatment stages effectively reduces and concentrates the PFAS-containing liquid waste stream(s) for disposal or destruction. With the reduced volume and increased concentration some destruction technologies, including electrochemical oxidation, will have improved destruction kinetics, reduced equipment footprint and energy consumption (smaller carbon footprint).

The generation and use of CGA for the purpose of separating and concentrating PFAS through rougher, concentrator and scavenger foam flotation stages can be accomplished internal and/or external to the CGA/PFAS separation vessel. Internal to the CGA generating reactor, liquid containing PFAS (e.g. RO rejects, groundwater, or leachate) can be blended with optional surfactant(s) and processed through the reactor where CGA bubbles are generated and rise to the surface of the same reactor vessel where the PFAS-laden foam can be partitioned and removed and reports downstream to a concentrator (enrichment) stage or directly to the PFAS disposal or destruction processes. Internal or external to the CGA reactor, foam can be removed, for example via a vacuum assisted pump, skimming, or a foam collection cone. Internal separation simplifies the operation and removal from the addition of a separation vessel.

As there is potential for PFAS to adsorb onto an insoluble particle already existing in the influent water, the use of a filter medium inside the invention apparatus can act as removal barrier to capture the particles containing PFAS further reducing the PFAS concentration in the retentate. In addition to filtering particles, the filter medium creates a barrier to contain the CGA bubbles from the retentate (below the media), minimizing cross contamination. Compressible media can be selected due to its high surface area (contact/solids loading) and high hydraulic loading rate.

Like a static mixer, the injection of influent water into the media can aid in the contact between the charged surfactant, CGA bubbles, and PFAS-containing liquid stream and is another variant for the use of a filter media.

The primary advantage of this invention is a new way that a type of CGA is generated in a lower shear environment utilizing commercially available pumps and an optional nozzle compared to the current CGA generation method developed by Dr Sebba and used by others utilizing a specialized high shear spinning dis.

Another advantage of the invention is a variant where the CGA is generated, utilized for PFAS removal, and separated within the same vessel.

Another advantage of this invention is that the type of CGA generated was successful at removing PFOS, a targeted PFAS proposed in the EPA's regulation.

Another advantage of this invention is CGA was utilized to reduce the PFAS containing waste stream volume reporting to destruction thus increasing energy efficiency of and economic viability of the total treatment process.

Another advantage of the invention is the use of a filter within the vessel for the separation of PFAS which has absorbed onto an insoluble particle or bubble that is retained in the filter and not the treated retentate.

Another advantage of the invention is the use of injecting into a filter media to aid increased contact between the charged surfactants, CGA bubbles and the PFAS-containing liquid stream.

Yet another advantage of this invention is utilizing CGA as a polishing step after a destruction treatment to remove any remaining PFAS utilizing CGA/or diffused gas in foam fractionation for additional removal and concentration that can be recycled back to destruction treatment again. This staged process of foam fractionation followed by destruction can be repeated indefinitely by blending foamate produced with an earlier concentration foam flotation stage or until the target level of PFAS remains in the liquid before reporting to discharge or other polishing treatment.

### DESCRIPTION OF THE DRAWINGS

FIG. 1 is a prior art schematic diagram illustrating rougher, scavenging and cleaner (enrichment) stages used to recover minerals in the mining industry, such stages and flow scheme also applicable to the removal and concentration of PFAS.

FIGS. 2 and 3 are actual generated microscopic-level images showing the multi-layer of the Colloidal Gas Aphron (CGA) bubbles generated by the invention and the differ.

FIGS. 4 and 4A show Dr Seba's work on CGA bubbles and their production, as prior art.

FIG. 5 is a schematic flow diagram illustrating a combined CGA bubble generation system and PFAS separation and removal concentration system.

FIG. 5A schematically shows a modification of the system in FIG. 5.

FIG. 5B shows a variation of FIG. 5 with a compressible filter section below CGA injection point.

FIG. 5C shows a variation of FIG. 5B with influent injected into the filter medium.

FIG. 6 is a schematic view showing an alternative to FIG. 5, shows a separate CGA/PFAS removal separator system.

FIG. 6A is a schematic drawing showing a variation CGA generation system using a nozzle.

FIG. 7 is a simplified process flow diagram showing PFAS concentration followed by destruction and polishing.

FIGS. 8 and 9 are flow diagrams illustrating staged concentration and destruction processes utilized for polishing remaining PFAS after deduction.

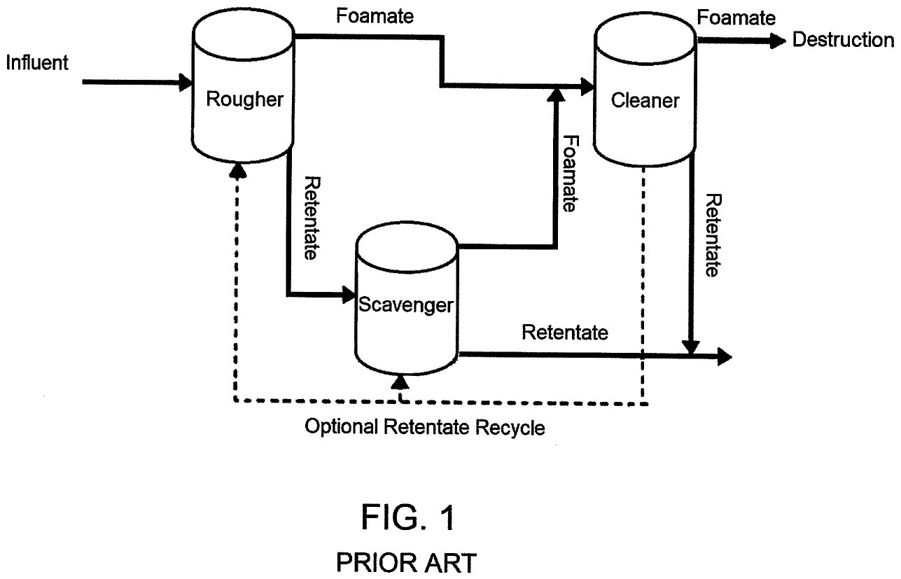

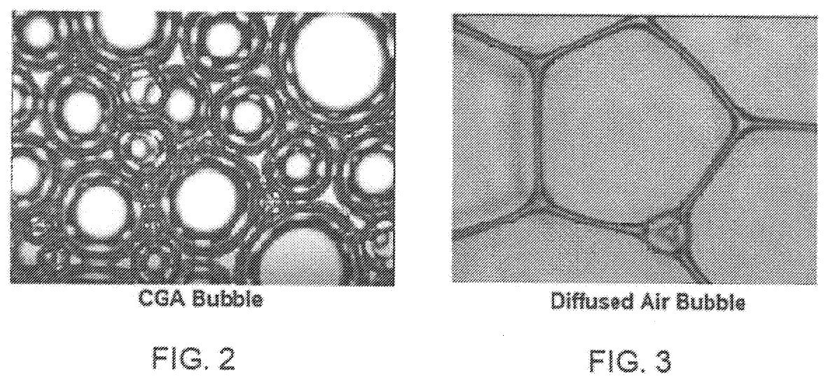

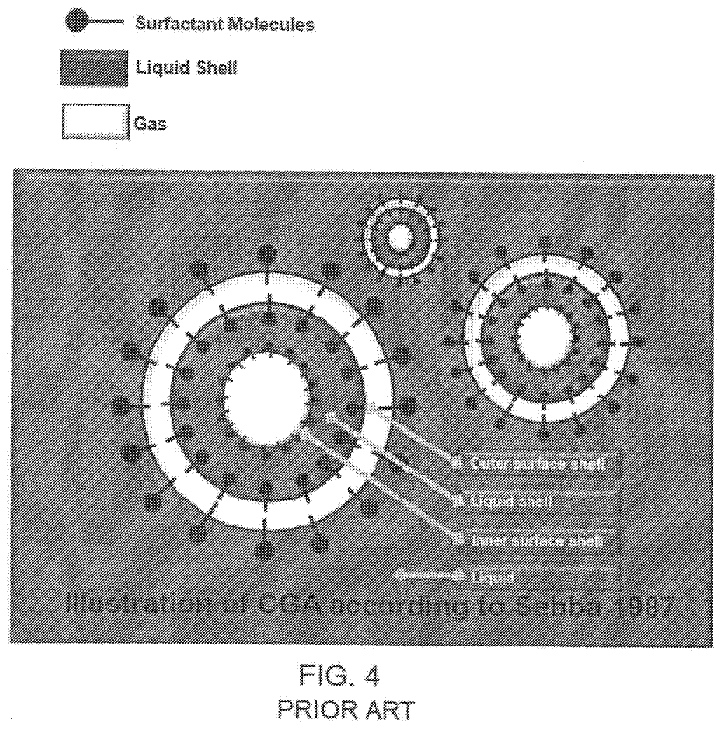

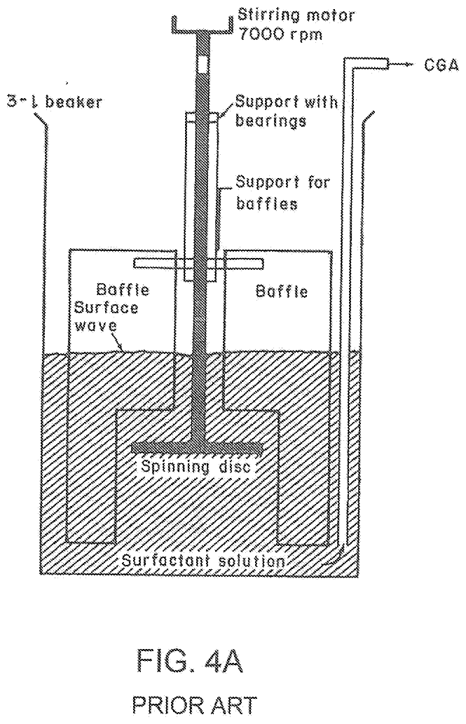

### DESCRIPTION OF PREFERRED EMBODIMENTS

In accordance with the present invention, a CGA generation system is structured to provide intimate mixing and interaction of various charged surfactants, water, and various gases (ozone, nitrogen, air, etc.). Design of the CGA contact mixing system promotes multilayer gas and liquid shell bubbles to maximize partitioning of known PFAS contaminants having a hydrophobic tail and charged head. By varying the surfactant type and mixing intensity, formation of CGA bubbles can influence the PFAS separation and concentration. While PFAS is a target contaminant, with this invention it is also possible for CGA to remove other contaminants like suspended solids, proteins and liquids from water and wastewater sources as referenced by Dr. Sebba's work.

The structure of the present invention may be adapted for use in a variety of industrial applications, but the invention is disclosed herein with respect to concentrating PFAS by way of example. The CGA system of the present invention includes a pump where a gas (usually air) can be induced into the suction side of an impeller type pump under varying pressures and mixing intensity. In addition, the use of a static mixer inline to the pump either on the suction or discharge side can be used to further facilitate the CGA bubbles and influent PFAS contaminant water interaction. Once formed, CGA bubbles are directed to a separation tank where the contaminants (PFAS) can further adsorb to CGA bubbles and rise to form a concentrated foam, and where the foam can ultimately be removed.

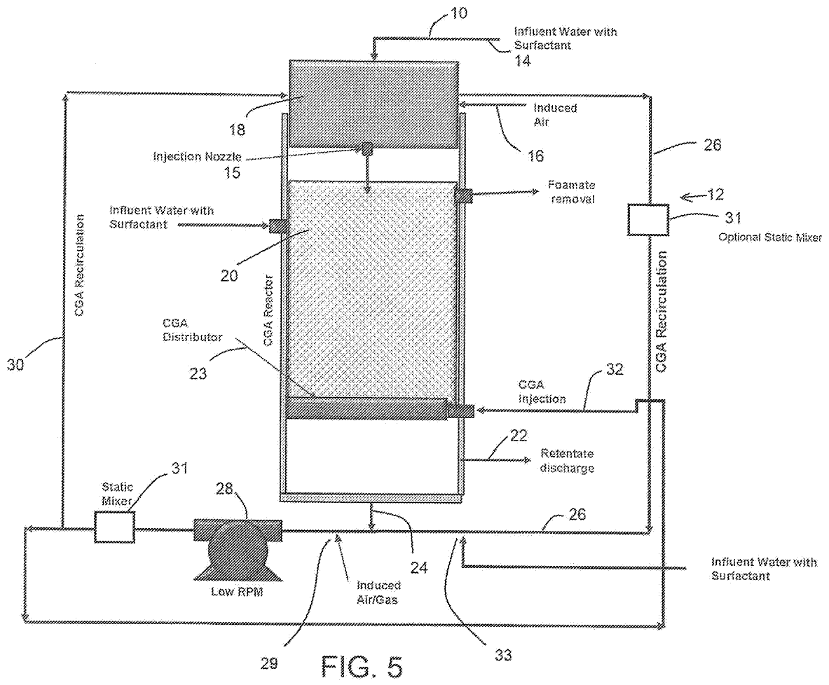

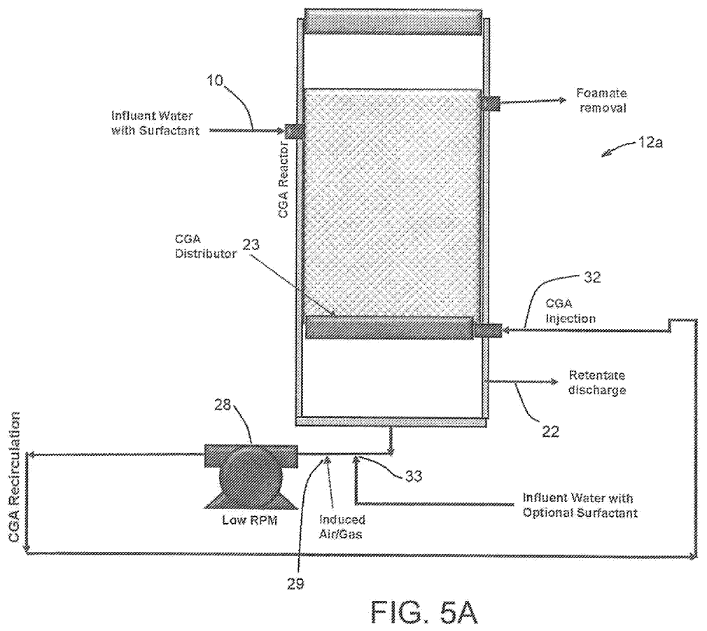

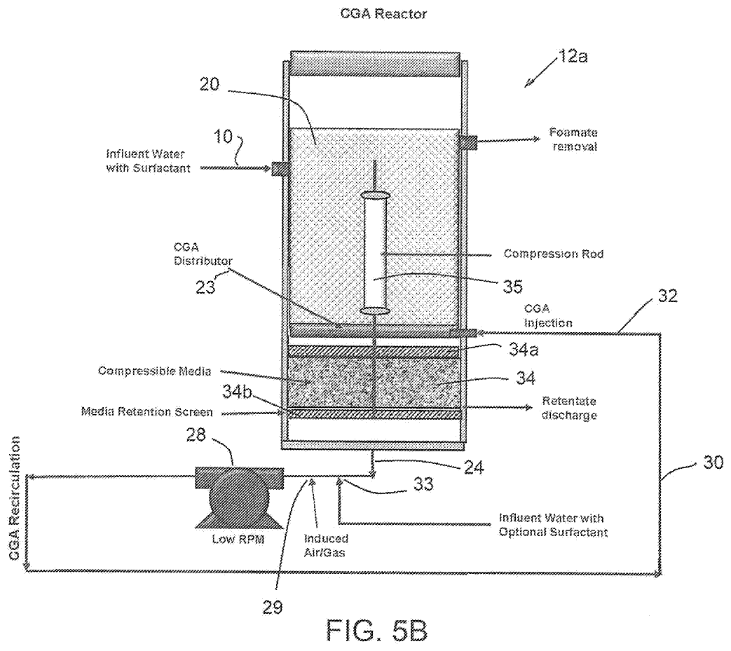

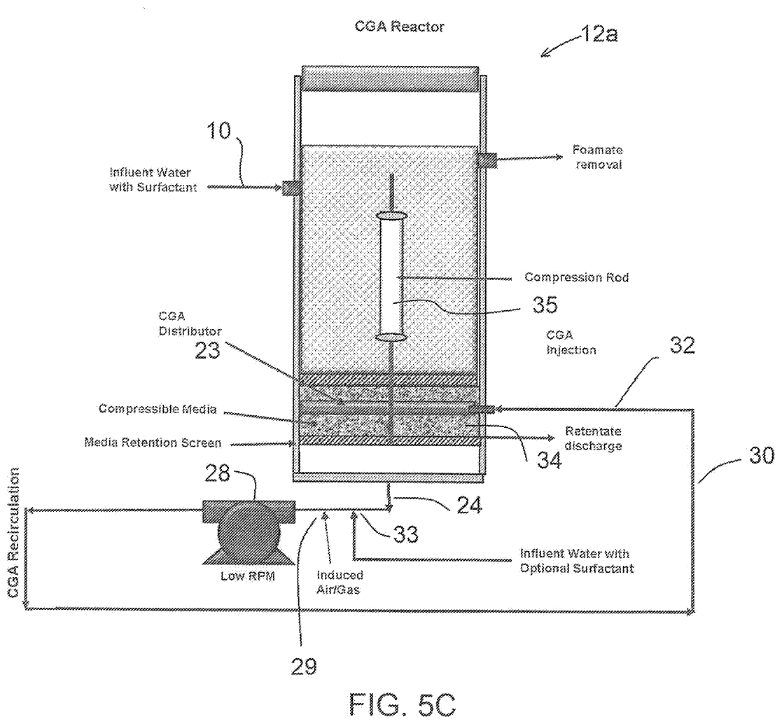

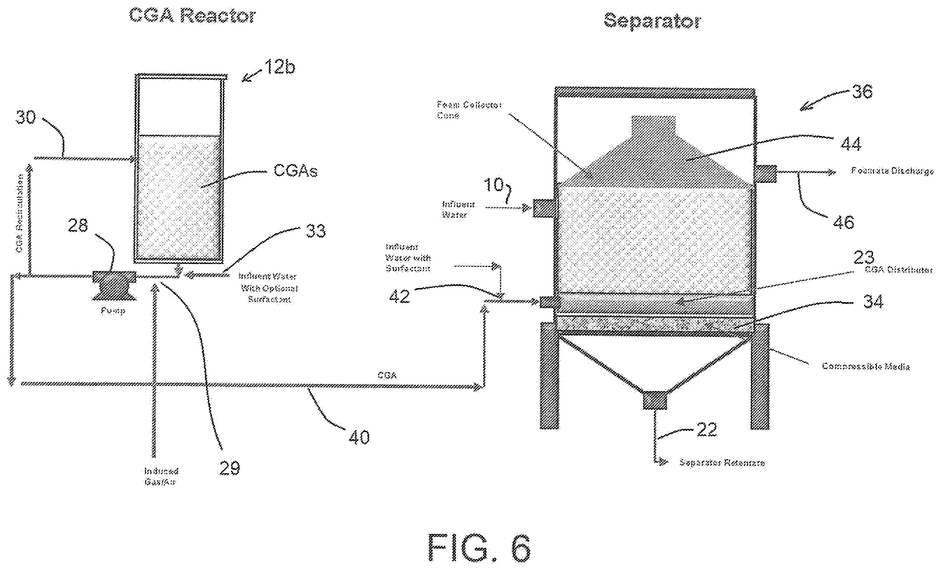

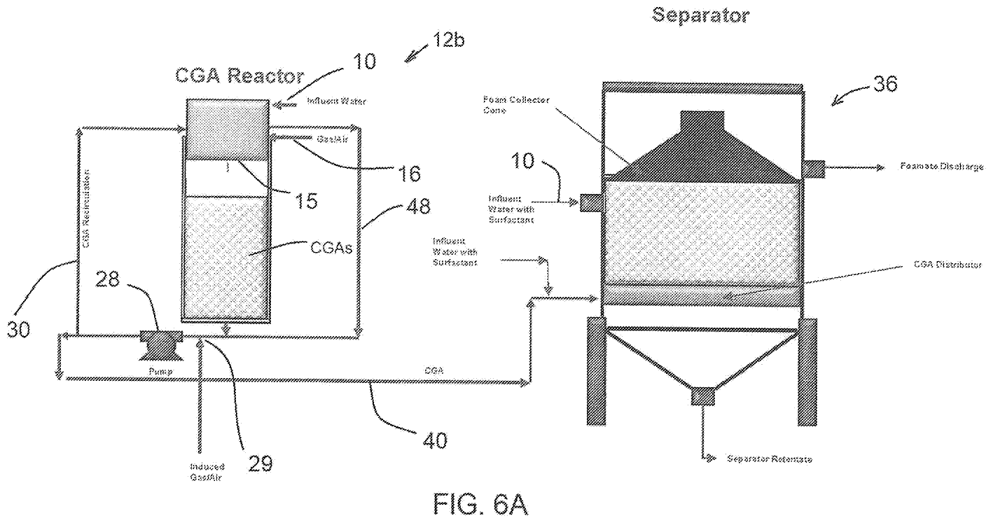

A combined CGA and PFAS separation system is schematically shown in FIG. 5. As shown in the diagram, water, that can be the water of interest containing PFAS, is admitted at 10 to a reactor 12, along with an optional surfactant indicated at 14. In the reactor the optional surfactant and water are mixed with a gas as indicated at 16. At this point CGAs can be generated via one or more nozzles shown at 15, through which the air is injected at high velocity. Alternatively, a commercially available pump or other low shear device can be positioned in the location shown at 28 of the reactor. The system shown in FIG. 5 is a single-vessel reactor. If the pump 28 is included, the system still is referred to as carrying out the reaction in a single reactor, even though the pump may be alongside the actual vessel, not within it. This is distinguished from the two-vessel reactor and separator in FIGS. 6 and 6A described below.

In another aspect of the invention surfactant is not added. The PFAS itself is a surfactant and in some cases can be at high enough concentration to create the CGAs based on their critical micelle concentration which is defined by is the concentration of a surfactant in a bulk phase, above which aggregates of surfactant molecules, start to form micelles. The reactor for CGA generation is a vessel which can be in the shape of a column. In this vessel the air, surfactant and water produce CGAs which are distributed throughout the vessel, with PFAS being sorbed onto the CGA bubbles, the bubbles rising to the upper portion of the vessel as a foam, shown as foamate at 20 in the drawing. At the bottom of the vessel water reduced in PFAS is withdrawn as retentate, at 22. The CGAs are being generated at the top of the vessel via the nozzle, in addition the CGAs are also generated at the pump and both generated CGAs will pass through the foam layer 20 and comingle with the liquid below in the vessel, and as described below, the system of circulation in this example introduces CGAs lower in the liquid in the vessel, at 32. The drawing shows preferred inclusion of a CGA distributor 23 where CGAs are injected and distributed into the bulk liquid.

FIG. 5 also shows circulation/recirculation of the CGAs. As indicated, preferably some of the liquid retentate at the bottom of the vessel is recycled as at 24, joining a flow that originates from the reactor at 18 as shown by the circulation line 26, drawn by a pump 28. The pump not only moves the liquid and CGAs, but also creates shear that generates more CGAs and maintains existing CGAs. CGA recirculation is indicated 30, back up to the top of the CGA reactor 12. The pump is a relatively low shear pump, at 5000 rpm or lower.

FIG. 5 also shows induced air entering the circulation line just upstream of a pump 28, at 29. The air is drawn in preferably by vacuum induced by the pump. The pump used to induce a gas into the process fluid may be, most suitably, a “self-inducing” pump either as a single or multi-impeller configuration. That is, a pump may be used in the system which is structured to circulate a liquid stream from the pump which induces gas into the liquid stream prior to re-entering the pump impeller. Alternatively, gas may be induced into the processed fluid recirculation line on the suction side of the pump or on the discharge side of the pump. The use of a pump or other apparatus for inducing the gas into the fluid line further eliminates the need for expensive equipment to introduce gas into the fluid line and eliminates the need to provide external gas or gas sources and also moves the liquid. However, it may be suitable, or even necessary, in some applications to introduce gas under metered conditions, which may be done in the present invention. Additionally, a multi-stage impeller pump having a series of in-line turbines which increases the mixing of the fluid discharged from the pump may be employed in the CGA system of the present invention to assure the mixing of gas with the fluid. Alternatively, a single-stage impeller pump may be used.

An optional in-line static mixer at 31 may be positioned downstream from the pump to receive fluid and induced gas. The optional in-line static mixer operates to mix the CGA bubbles and contaminated fluid under atmospheric or pressurized conditions. The static mixer can take any of several forms, such as a tortuous helical path, a bed of small (e.g. 1 mm) beads, a wire mesh, etc. FIG. 5 also shows entry of influent water with optional surfactant farther upstream of the pump, at 33, also induced by the suction of the pump. This is a feature that can be included, supplementing the water/surfactant brought in at 10. If desired the influent 10 shown at top can be eliminated, such that all influent enters at 33.

FIG. 5A shows a variation of FIG. 5, also illustrating the system wherein CGAs are produced and removed within the main reaction vessel 12a. In this case the CGAs are not formed at the top of the vessel, i.e. without a nozzle or nozzles at that location and only at the pump 28. Here, the pump 28 induces upstream suction, with induced air or gas again shown entering the line at 29. This arrangement has been found sufficient to generate CGAs efficiently, and with the use of a nozzle. Influent water with optional surfactants is indicated as entering the same line further upstream from the pump at 33, and upstream of the induced air/gas 29. FIG. 5A also shows that influent water with optional surfactants can be introduced at 10, such that the influent water is brought in at two different points. If desired this could be reduced to one entry point. At the same time, the pump delivers a part of the CGA/water volume into the vessel as indicated at 32, this flow being rich in CGAs, and this may be via a CGA distributor 23.

In the system of FIG. 5A, the pump thus serves three distinct functions: movement/circulation of CGAs (along with contaminated water); generation of the CGAs by shear/mixing; and bringing in at least some or all of the contaminated water via the suction side of the pump.

FIG. 5B shows a single-vessel system as in FIG. 5A, but with a compressible filter medium 34 through which the PFAS-reduced water will pass as it descends to the retentate exit at 24. The medium is retained by upper and lower retention screens 34a and 34b. This is a dynamic filter medium, in that it is initially compressed to a defined maximum, but as the medium fills with particles that have attached PFAS and descended, pressure increases above the filter medium, which is sensed by a pressure sensor, or timed, or turbidity, as is known from other uses of compressible media, and a compression assembly schematically indicated at 35 is automatically caused to ease the compression incrementally until the medium has been fully expanded for backwashing with air and water, the particles are removed from the medium surface. Thereafter when the back pressure indicates the medium is full and inefficient for any further filtration, the system is taken offline briefly for backwashing of the medium with air and water or another fluid. Once the filter medium has been backwashed to a cleaned state, the filter is brought back into service at a predetermined compression.

Alternatively, a fixed filter medium can be used at 34, and either type of filter medium can be used in any of the systems shown in FIGS. 5-6A.

FIG. 5C shows a variation of the system of FIG. 5B, wherein the CGAs with water are injected via the line 32 into the filter medium 34, which can be through a distributor 23 as discussed above. In this way the filter medium 34 serves both to filter out particles from the descending water, and to enhance comingling of the water, PFAS and CGAs via a tortuous upward path.

In contrast to the single-vessel reactor, separation can be external to the CGA reactor, as shown in FIGS. 6 and 6A. CGA bubbles are first generated in or alongside a reactor 18 and then moved with a pump 28 and introduced into a separation vessel 36 to be commingled with the PFAS-containing liquid stream 10. A further influent stream can be introduced at 42 where the CGA stream enters or at 40 As above, the air/gas, water and surfactants can be injected via one or more nozzles 15, as shown in FIG. 6A. Alternatively, as in FIG. 6, the CGAs can be formed solely at the pump 28, via an induced air entry 29 and an injection of water, optional surfactant and air/gas, just upstream of the induced entry, at 33, similarly to what is shown in FIG. 5A.

In FIG. 6, the CGAs are formed at only the pump 28, preferably with a part of the stream of CGAs sent into the reactor 12b, via a recirculation line 30 and the remainder delivered through a line 40 to be joined with influent contaminated water at 42; surfactant can be added to the influent water if needed. The water and CGAs preferably enter the separator vessel via a CGA distributor 23. As noted above, influent water can additionally, or alternatively, be added to the separator vessel 36 at an upper position 10 in the vessel, as indicated in the drawing. In the separation vessel 36 the PFAS-containing foam rises to the surface; a foam collector cone 44 can optionally be included in the vessel, so that foam rises and flows out the top of the cone, to be discharged at 46, to be removed to a collection tank (not shown) before reporting to a concentrator enrichment foam flotation stage or to PFAS destruction treatment. Foam could also be removed and collected by other means such as skimming or vacuuming. At the bottom of the separator 36 a filter medium 34 can be included for filtration of the retentate as discussed above, and this can be compressible or non-compressible (eg multimedia filtration, activated carbon filtration, ceramic membrane). The filter included within the generation and/or separation steps can also be utilized for enhanced removal of PFAS which has absorbed/adsorbed onto an insoluble particle or bubble that is retained in the filter and not entering the treated retentate from the system. Alternatively, the retentate can be discharged without filtration. The retentate is discharged at 22, for further separation, polishing or destruction.

FIG. 6A is a similar in many respects to FIG. 6, except in regard to generation of CGAs in the reactor. Influent water and gas/air are injected at the top of the reactor at 10, 16 and exit through a nozzle(s) 15 to produce CGAs. A slip stream 48 is shown, recirculating part of the CGA from line 30, and optionally some of the influent can be blended in-line 48. This stream is sent to the pump 28, which maintains and helps generate the CGAs. The pump can draw in air/gas as at 29 if needed, and could also draw in influent water if needed, as in FIG. 6. The CGA output of the pump 28 is partially recirculated in the line 30 to the nozzle area, and partially sent via the line 40 to the separator vessel.

The use of a compressible filter medium), or static mixer(s) inside the separator or CGA reactor, both allow for increased contact between the PFAS and bubbles. The filter medium forces the bubble to take a tumultuous path while at the same time removing insoluble material, producing a more clarified liquid stream. FIG. 5C shows an example reactor using polyphenylene sulfide (PPS) compressible media internal to the CGA reactor.

It should be understood that in the system of the invention, in all embodiments, non-CGA air (or gas) bubbles can be generated and used along with CGAs to enhance PFAS sorption. In the systems of FIGS. 5-5C the non-CGA bubbles can be generated in the reactor/separator to mingle with the CGAs, or they can be formed separately and injected into the separator. This is also true for FIGS. 6 and 6A.

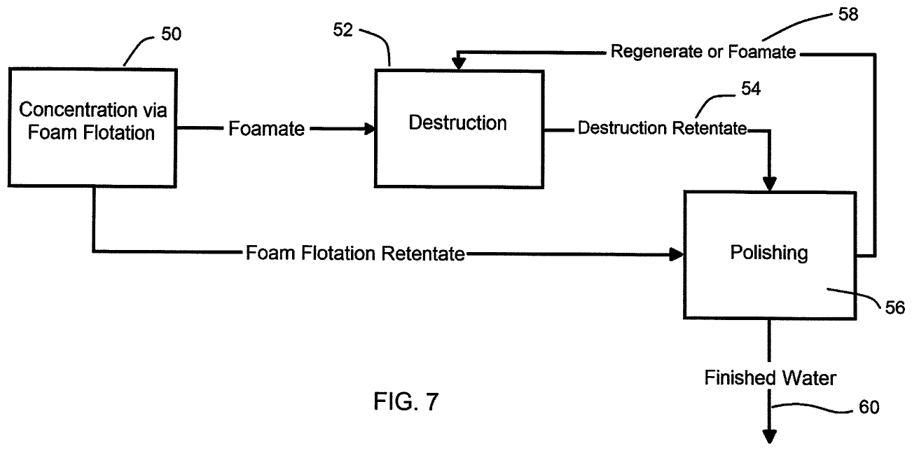

As outlined in FIG. 7 the collected foamate 50 from the rougher, cleaner or, or scavenger (i.e. the CGA generator) stages reports to a destruction treatment process 52 and the foam flotation retentate 54 can be discharged or sent to a polishing stage 56. The polishing stage can consist of either regenerable or non-regenerable adsorption media, reverse osmosis, or a scavenger foam fractionation process to further concentrate the PFAS from the foamate and/or remove residual PFAS from the destruction retentate 54. The PFAS-containing foamate or regenerate 58 produced from any polishing process can be recycled back to the destruction treatment system as shown. Finished water is shown at 60 discharged from the polishing step.

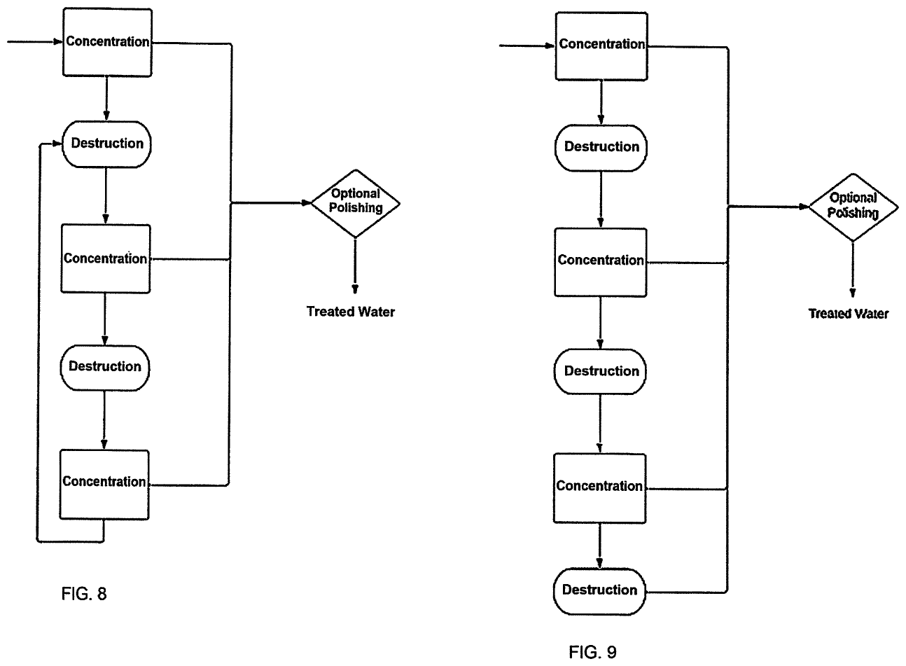

Froth/Foam floatation steps may be used in multiple stages in combination with PFAS destruction processes as outlined in the diagrams of FIGS. 8 and 9. This staged treatment system that combines both destruction and foam flotation can be employed with PFAS destruction methods that are the most energy efficient when the concentration of PFAS in the liquids is relatively high. With these types of PFAS destruction methods, over time during treatment the concentration of PFAS will be reduced along with the energy efficiency of the destruction and there will be a point where increasing treatment time returns value. To increase energy efficiency of these type of destruction methods when the energy efficiency of these type of destruction process or concentration of PFAS drops below a certain level the liquid will report to another round of concentration by foam flotation, as shown in FIG. 9. The additional concentration stage of foam flotation will further reduce the liquid volume needing destruction treatment and increase the concentration of PFAS before reporting back to destruction processing. This staged process of foam fractionation followed by destruction can be repeated indefinitely by blending foamate produced with an earlier concentration foam flotation stage or until the target level of PFAS remains in the liquid before reporting to polishing.

### EXAMPLES

### Example 1

In July 2022, a volume of 5 liters of RO (reverse osmosis) concentrate was treated with a process of the invention. The PFAS in the RO Concentrate were initially analyzed by Liquid Chromatography with Tandem Mass Spectrometry (LC-MS-MS) and was found to have a starting concentration of 140 parts per trillion (ppt) of PFOS and 89 ppt of PFOA. A mixture of surfactants was added, and the above-described foam flotation procedure was conducted. Results showed that the use of foam fractionation removed both PFOS and PFOA (target PFAS) in addition to other detectable PFAS as shown below. All analytical results were performed by a third-party certified lab and the results of the analysis were found to be undetectable for all but two PFAS namely PFPeA and PFBA in the treated liquid (retentate). The table below presents the results of the analysis.

| | RO Concentrate | Post Treatment | MDL |
|---|---|---|---|
| Compound | (ppt) | (ppt) | (ppt) |
| PFBS | 40 | ND | 2.2 |
| PFHxS | 25 | ND | 2.4 |
| PFBA | 96 | 94 | 2.0 |
| PFDA | ND | ND | 2.6 |
| PFHpA | 28 | ND | 2.5 |
| PFHxA | 51 | ND | 2.0 |
| PFNA | 2.3 | ND | 3.5 |
| PFOA | 89 | ND | 2.7 |
| PFPeA | 33 | 19 | 2.0 |
| PFOS | 140 | ND | 2.5 |

The foam collected off the top of the mixture was 3.5% the initial volume and highly concentrated with the PFAS. The 3.5% highly concentrated volume of PFAS liquid can report directly to a destruction process or be further concentrated by an additional foam flotation process.

### Example 2

In March of 2023, a large volume of RO concentrate was treated with a process of the invention and the foamate collected was treated by electrochemical oxidation, a PFAS detection technology. The concentrations of PFAS remaining in the foamate after processing with a destruction technology were analyzed by LC-MS-MS and were found to contain detectable levels of PFBA, PFHxA, PFOA, PFPeA, and PFOS as shown in table below in column Post Destruction. A volume of 5 L of the post destruction treated foamate was then again treated with a process of the invention for polishing/removing remaining PFAS for 15 minutes. The retentate from the polishing treatment was analyzed by LC-MS-MS and results are shown in the column in the table below labeled Post Polishing Using CGA. The results indicate the remaining PFHxA, PFOA, and PFAS concentrations after destruction were treated to non-detections and further removal of PFBA was achieved in the retentate with the CGA polishing. The foamate containing the concentrated PFAS was collected and also analyzed with LC-MS-MS and concentration reported in the column labeled Foamate. The volume was found to be less than 10 ml and could be treated again with the destruction technology for further PFAS reduction and mineralization.

| | Post | Post Polishing | |
|---|---|---|---|
| Compound | Destruction (ppt) | Using CGA (ppt) | Foamate (ppt) |
| PFBS | ND | ND | 910 |
| PFHxS | ND | ND | 670 |
| PFBA | 71.3 | 59 | 130 |
| PFDA | ND | ND | 27 |
| PFHpA | ND | ND | 770 |
| PFHxA | 44.4 | ND | 1,100 |
| PFNA | ND | ND | 81 |
| PFOA | 14.3 | ND | 3,200 |
| PFPeA | 14.3 | ND | 150 |
| PFOS | 10.8 | ND | 4,800 |

The above-described preferred embodiments are intended to illustrate the principles of the invention, but not to limit its scope. Other embodiments and variations to these preferred embodiments will be apparent to those skilled in the art and may be made without departing from the spirit and scope of the invention as defined in the following claims.

We claim:

1. A method for removal of PFAS from drinking water, wastewater, and other solids and liquid applications, comprising:
generating Colloidal Gas Aphrons (CGAs) by subjecting a mixture of a gas, water, and one or more surfactants to low shear forces in a pump operated at or below 5000 rpm, or by introducing shear by injecting the mixture through an injection nozzle,
allowing the CGAs to rise in a vessel in which the CGAs move upward through PFAS-containing water, extracting PFAS from the water, and generating a foam layer at an upper surface of the water,
removing the foam with concentrated PFAS-containing CGAs from the surface of the water so that a retentate water remaining in a bottom of the vessel contains lower PFAS concentration,
withdrawing the retentate water from the bottom of the vessel, and
allowing the foam to collapse into to a small volume of PFAS-concentrated liquid after removal and subjecting the PFAS-concentrated liquid to further treatment, destruction or disposal.

2. The method of claim 1, wherein the CGAs are generated in said vessel or in a fluid line connected to said vessel.

3. The method of claim 1, wherein the CGAs are generated in a CGA generator vessel separate from said vessel.

4. The method of claim 1, wherein surfactants are added and include charged and non-charged surfactants.

5. The method of claim 1, without addition of surfactant, said PFAS being the surfactant.

6. The method of claim 1, wherein the CGAs are in part recirculated from a stream of CGAs from said generating step, by a pump back to the generating step.

7. The method of claim 1, wherein CGAs are generated by said pump operated at or below 5000 rpm, the pump positioned to receive influent water with surfactant and to draw air or gas into the pump from a suction side of the pump, and the pump positioned to deliver water and CGAs into said vessel so that the CGAs rise upward through the PFAS-containing water.

8. The method of claim 7, wherein a part of the retentate water enters the suction side of the pump.

9. The method of claim 7, further including introducing influent water with surfactant into the vessel directly.

10. The method of claim 7, wherein influent water with surfactant and air or gas is also injected into the vessel through said injection nozzle, so that the CGAs are generated by both the pump and the injection nozzle and including recirculating a part of the CGAs from the pump back to the injection nozzle.

11. The method of claim 10, further including filtering the retentate water before discharge from the vessel with a filter medium near the bottom of the vessel, to remove particles and enhance PFAS removal.

12. The method of claim 11, wherein the filter medium is a compressible medium.

13. The method of claim 1, further including filtering the retentate water before discharge from the vessel with a filter medium near the bottom of the vessel, to remove particles to enhance PFAS removal.

14. The method of claim 13, wherein the filter medium comprises a ceramic membrane, multimedia filtration, or activated carbon.

15. The method of claim 13, wherein the filter medium is a compressible medium.

16. The method of claim 1, wherein the removal of PFAS includes removal of PFOS.

17. The method of claim 1, further including generating or introducing non-CGA diffused gas in the water for acting along with the CGAs in the vessel for further sorption of PFAS.

18. The method of claim 1, wherein the vessel includes a filter medium positioned to remove particles from water descending in the vessel, and also positioned to receive influent water such that CGAs in the vessel are caused to mix and intermingle with the influent water to enhance PFAS attachment to the CGAs.

19. The method of claim 1, further including, after destruction of the PFAS-concentrated liquid produced from the foam, further processing destruction treated water in a polishing step using CGAs to generate a further foam containing CGAs and PFAS, further reducing PFAS concentration in the PFAS-concentrated liquid.

20. A method for removal of solids, surfactants including PFAS, or other contaminants from drinking water, wastewater, and other solids and liquid applications, comprising:
generating Colloidal Gas Aphrons (CGAs) by subjecting a mixture of a gas, water, and one or more surfactants to low shear forces in a pump, the pump being positioned to receive influent water with surfactant and to draw air or gas into the pump from a suction side of the pump, and the pump positioned to deliver water and CGAs into said vessel so that the CGAs rise upward through the contaminant-containing water,
allowing the CGAs to rise in a vessel in which the CGAs move upward through contaminant-containing water, extracting contaminants from the water, and generating a foam layer at an upper surface of the water,
removing the foam with concentrated contaminant containing CGAs from the surface of the water so that a retentate water remaining in a bottom of the vessel contains lower contaminant concentration,
withdrawing the retentate water from the bottom of the vessel, and
allowing the foam to collapse into to a small volume of contaminant-concentrated liquid after removal and subjecting the contaminant-concentrated liquid to further treatment, destruction or disposal.

21. The method of claim 20, wherein the CGAs are generated in said vessel or in a fluid line connected to said vessel.

22. The method of claim 20, wherein surfactants are added and include charged and non-charged surfactants.

23. The method of claim 20, wherein CGAs are generated by said pump positioned to receive influent water with surfactant and to draw air or gas into the pump from a suction side of the pump, and the pump positioned to deliver water and CGAs into said vessel so that the CGAs rise upward through the contaminant-containing water.

24. The method of claim 23, further including introducing influent water with surfactant into the vessel directly.

25. The method of claim 23, wherein influent water with surfactant and air or gas is also injected into the vessel through an injection nozzle, so that the CGAs are generated by both the pump and the injection nozzle and including recirculating a part of the CGAs from the pump back to the injection nozzle.

26. The method of claim 20, further including filtering the retentate water before discharge from the vessel with a filter medium near the bottom of the vessel, to remove particles to enhance contaminant removal.

27. The method of claim 26, wherein the filter medium is a compressible medium.

28. The method of claim 20, further including generating or introducing non-CGA diffused gas in the water for acting along with the CGAs in the vessel for further sorption of contaminants.

29. The method of claim 1, wherein the vessel includes a filter medium positioned to remove particles from water descending in the vessel, and also positioned to receive influent water such that CGAs in the vessel are caused to mix and intermingle with the influent water to enhance contaminant attachment to the CGAs.
